(19) United States
(12) Patent Application Publication
(10) Pub. No.: US 2025/0079890 A1
(43) Pub. Date: Mar. 6, 2025

(54) DUMBBELL COIL FOR WIRELESS POWER TRANSFER

(71) Applicant: Renesas Electronics America Inc., Milpitas, CA (US)

(72) Inventors: Sheng Yuan, Putuo District, Shanghai (CN); Jiangjian Huang, Milpitas, CA (US); Bo Tang, Chengdu, Sichuan (CN); Hulong Zeng, San Jose, CA (US)

(73) Assignee: Renesas Electronics America Inc., Milpitas, CA (US)

(21) Appl. No.: 18/043,433

(22) PCT Filed: Dec. 30, 2022
(86) PCT No.: PCT/CN2022/144357

§ 371 Date: Feb. 28, 2023

(51) Int. Cl. H02J 50/10; H01F 27/24; H01F 27/30

(52) U.S. Cl. CPC H02J 50/10; H01F 27/24; H01F 27/306

(57) ABSTRACT

A wireless power apparatus may include a power receiver having an elongated core member with a long axis and a receiver conductor wound spirally around the elongated core member to form an elongated receiver coil, the power receiver configured to receive power from a power transmitter having a transmitter conductor being wound circularly around a center point and disposed in a plane to form a planar transmitter coil, the planar transmitter coil configured to be connected to an alternating current power source to wirelessly transmit power, the planar transmitter coil having a transmitter coil radial axis starting at the center point and defining a transmitting region from an inner edge of the planar transmitter coil to an outer edge of the planar transmitter coil along the transmitter coil radial axis.

### BACKGROUND

The present disclosure relates in general to systems, apparatuses and methods including wireless power transfer in a dumbbell coil configuration.

Wireless power transfer (WPT) systems may include a power transmitter having a transmission coil and a power receiver having a receiver coil. The transmission coil and the receiver coil may be brought close to one another to form a transformer that can facilitate inductive transmission of alternating current (AC) power. The transfer of AC power, from the transmitter to the receiver, can facilitate powering a device containing the receiver coil, or charging of a battery of the device including the receiver. As the dimensions of wearable electronic devices become smaller, the utility of conventional planar receiver coils may become limited, where both the charging area and charging efficiency of conventional planar receiver coils may be affected. Also, a receiver coil may usually be a smaller version of a larger transmitter coil, so placement of the smaller receiver coil placed on or placed in proximity to the larger transmitter coil may be crucial to effective power transfer during wireless charging. A solution is needed to address these issues and others.

### SUMMARY

In one embodiment, a wireless power system is generally described. The wireless power system may include an alternating current power source configured to provide electrical power, a power transmitter having a transmitter conductor being wound circularly around a center point and disposed in a plane to form a planar transmitter coil, the planar transmitter coil configured to be connected to the alternating current power source to wirelessly transmit power, the planar transmitter coil having a transmitter coil radial axis starting at the center point and defining a transmitting region from an inner edge of the planar transmitter coil to an outer edge of the planar transmitter coil along the transmitter coil radial axis, a power receiver having an elongated core member with a long axis and a receiver conductor wound spirally around the elongated core member to form an elongated receiver coil, and a load connected to the elongated receiver coil and configured to receive power from the planar transmitter coil when the elongated receiver coil is in proximity to the transmitting region.

In one embodiment, a wireless power apparatus is generally described. The wireless power apparatus may include a power receiver having an elongated core member with a long axis and a receiver conductor wound spirally around the elongated core member to form an elongated receiver coil, the power receiver configured to receive power from a power transmitter having a transmitter conductor being wound circularly around a center point and disposed in a plane to form a planar transmitter coil, the planar transmitter coil configured to be connected to an alternating current power source to wirelessly transmit power, the planar transmitter coil having a transmitter coil radial axis starting at the center point and defining a transmitting region from an inner edge of the planar transmitter coil to an outer edge of the planar transmitter coil along the transmitter coil radial axis.

In one embodiment, a method for constructing a wireless power apparatus is generally described. The method may include forming a power receiver having an elongated core member with a long axis and a receiver conductor wound spirally around the elongated core member to form an elongated receiver coil, the power receiver configured to receive power from a power transmitter having a transmitter conductor being wound circularly around a center point and disposed in a plane to form a planar transmitter coil, the planar transmitter coil configured to be connected to an alternating current power source to wirelessly transmit power, the planar transmitter coil having a transmitter coil radial axis starting at the center point and defining a transmitting region from an inner edge of the planar transmitter coil to an outer edge of the planar transmitter coil along the transmitter coil radial axis.

Further features as well as the structure and operation of various embodiments are described in detail below with reference to the accompanying drawings. In the drawings, like reference numbers may indicate identical or functionally similar elements.

### BRIEF DESCRIPTION OF THE DRAWINGS

FIG. 1 is a block diagram of an example wireless power system according to an embodiment.

FIG. 2 is a diagram showing an example power transmitter according to an embodiment.

FIG. 3 is a diagram showing an example power receiver in a dumbbell configuration according to an embodiment.

FIG. 4 is a diagram showing an example power receiver in a dumbbell configuration having two arms according to an embodiment.

FIGS. 5A-5C illustrate exemplary placements of a receiver coil in proximity to a transmitter coil according to an embodiment.

FIGS. 6A-6C are diagrams showing an example power receiver in a dumbbell configuration having three arms and placement of the power receiver adjacent to a power transmitter according to an embodiment.

FIG. 7 is a diagram showing an example power receiver in a dumbbell configuration having four arms according to an embodiment.

FIG. 8 is a chart showing a comparison based on system efficiency and output current for a planar coil and a dumbbell coil according to an embodiment.

FIGS. 9A-9H are a flow diagram of a method according to an embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

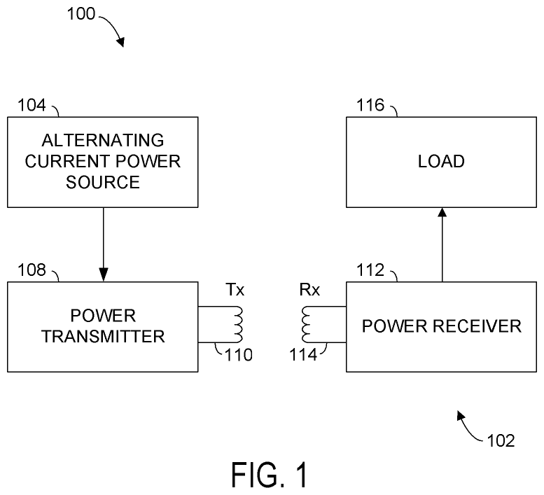

FIG. 1 is a block diagram of an example wireless power system 100 according to an embodiment. System 100 may include an alternating current (AC) power source 104 and a power transmitter 108 having a transmitter conductor 110 (e.g. a transmitter coil) configured to transmit power received from alternating current power source 104. System 100 may include a power receiver 112 having a receiver conductor 114 (e.g. a receiver coil) configured to receive power transmitted from transmitter conductor 110. Finally, system 100 may include a load 116 such as a power consuming device such as a cellular telephone, smart watch, smart phone, or a music playing device. Load 116 may also include a power storing device such as a battery along with various electronic components to facilitate the reception, consumption, and storage of power in load 116. A wireless power apparatus 102 may include power receiver 112, receiver conductor 114, and or load 116 which may be connected to receiver coil 114 and configured to receive power from planar transmitter coil 110 when receiver coil 114 may be in proximity to transmitter coil 110. In this manner, power from alternating current power source 104 may be transferred to load 116 via inductive coupling between transmitter conductor 110 and receiver conductor 114 which form a transformer so that wireless power transfer (WPT) may be accomplished using a near field power transfer technique.

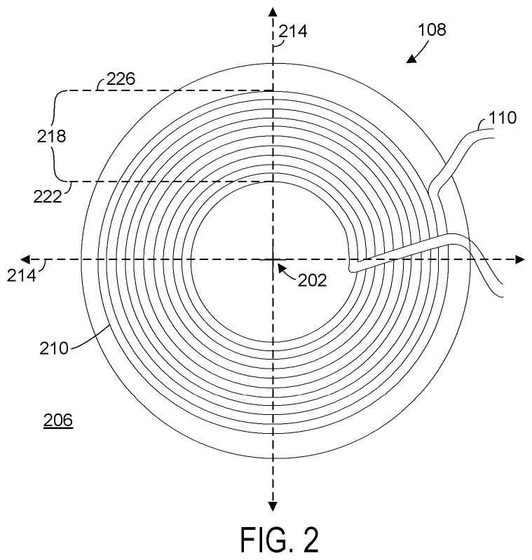

FIG. 2 is a diagram showing an example power transmitter 108 according to an embodiment. Power transmitter 108 may include a transmitter conductor 110 configured to conduct and radiate electrical energy. Transmitter conductor 110 may be wound circularly around a center point 202 and disposed in a plane 206 to form a planar transmitter coil 210 configured to be connected to an alternating current power source. Planar transmitter coil 110 may have a transmitter coil radial axis 214 starting at center point 202 and defining a transmitting region 218 from an inner edge 222 of planar transmitter coil 110 to an outer edge 226 of planar transmitter coil 110 along transmitter coil radial axis 214. In this manner, planar transmitter coil 110 includes a ring-shaped transmitting region surrounding center point 202.

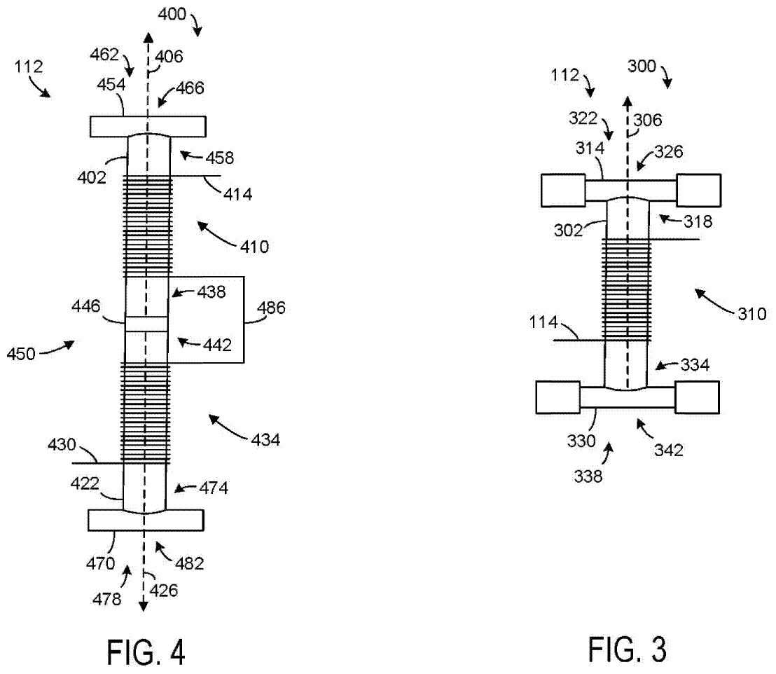

FIG. 3 is a diagram showing an example power receiver in a dumbbell configuration according to an embodiment. Power receiver 112, as an example power receiver 300, may have an elongated core member 302 with a long axis 306 and a receiver conductor 114 configured to receive and conduct electrical energy, receiver conductor 114 being wound spirally around the elongated core member to form an elongated receiver coil 310. In this manner, power receiver 300 may resemble a bar-shaped receiver coil (e.g. a rod coil) which could be rectangular or cylindrical in shape. Power receiver 300 may include a first end member 314 connected to a first end 318 of elongated core member 302. First end member 314 may be an elongated member 322 having a middle portion 326 that may be attached to the first end of elongated core member 302. First end member 314 may include a ferrous material (e.g. a ferromagnetic material, such as ferrite, containing iron and susceptible to magnetic fields) and may be magnetically coupled to elongated core member 302. The presence of a ferrous material, or a ferrous compound, in various disclosed structures, such as elongated receiver coil 310 and first end member 314, may improve charging performance, for example. Alternatively, first end member 314 may not include ferrous material but may instead include non-ferrous materials such as plastic or another non-magnetic material to provide various structural or physically supporting features. In this manner, power receiver 300 with first end member 314 may resemble a T-shaped receiver coil. Further, power receiver 112 may include a second end member 330 that may be connected to a second end 334 of elongated core member 302 opposite first end 318. Second end member 330 may be an elongated member 338 having a middle portion 342 that may be attached to second end 334 of elongated core member 302. Second end member 330 may include a ferrous material and may be magnetically coupled to elongated core member 302. In this manner, power receiver 300 with first end member 314 and second end member 330 may resemble a dumbbell-shaped receiver coil. Alternatively, either or both of first end member 314 and second end member 330 may be attached to elongated core member 302 at another point that is not at their middle portions (326, 342) respectively. During mass production, elongated core member 302, first end member 314, and second end member 330 may be formed as a whole, contiguous piece of ferrite in a molding process.

In reference to FIG. 1, FIG. 2, and FIG. 3, a wireless power system 100 may include alternating current power source 104 configured to provide electrical power, power transmitter 108 having a transmitter conductor 110 being wound circularly around center point 202 and disposed in plane 206 to form planar transmitter coil 210 configured to be connected to alternating current power source 104 to wirelessly transmit power. Planar transmitter coil 110 may have transmitter coil radial axis 214 starting at center point 202 and defining transmitting region 218 from inner edge 222 of planar transmitter coil 110 to outer edge 226 of planar transmitter coil 110 along transmitter coil radial axis 214. Power receiver 112 may have elongated core member 302 with long axis 306 and receiver conductor 114 wound spirally around elongated core member 302 to form elongated receiver coil 310. Wireless power system 100 may also include load 116 connected to elongated receiver coil 310 configured to receive power from planar transmitter coil 210 when elongated receiver coil 310 may be in proximity to transmitting region 218. As used herein, elongated receiver coil 310 being in proximity to transmitting region 218 includes elongated receiver coil 310 being adjacent to transmitting region 218 in a direction perpendicular to plane 206. Further, wireless power apparatus 102 may include power receiver 112 having elongated core member 302 with long axis 306 and receiver conductor 114 wound spirally around elongated core member 302 to form elongated receiver coil 310. Power receiver 112 may receive power from power transmitter 108 having transmitter conductor 110 wound circularly around center point 202 and disposed in a plane 206 to form planar transmitter coil 210. Planar transmitter coil 210 may be connected to alternating current power source 104 to wirelessly transmit power. Planar transmitter coil 210 may have transmitter coil radial axis 214 starting at center point 202 and defining transmitting region 218 from inner edge 222 of planar transmitter coil 210 to outer edge 226 of planar transmitter coil 210 along transmitter coil radial axis 214.

FIG. 4 is a diagram showing an example power receiver in a dumbbell configuration having two arms according to an embodiment. Power receiver 112, as an example power receiver 400, may include a first elongated receiver coil 410 having a first elongated core member 402 with a first long axis 406 and a first receiver conductor 414 wound spirally around first elongated core member 402. Power receiver 400 may further include a second elongated core member 422 with a second long axis 426 and a second receiver conductor 430 wound spirally around second elongated core member 422 to form a second elongated receiver coil 434, wherein second elongated core member 422 may be disposed coaxially with first elongated core member 402. Further, a second end 438 of first elongated core member 402 may be connected to a second end 442 of second elongated core member 422. In this manner, power receiver 400 may resemble a bar shaped receiver coil having two arms, with a first receiver conductor 414 and a second receiver conductor 430 displaced along the connected and coaxial elongated core member 402 and elongated core member 422, respectively. First receiver conductor 414 and second receiver conductor 430 may be connected together serially by a direction connection 486, a jumper wire, or other suitable connection method to form a continuous wire. The distance between first receiver conductor 414 and second receiver conductor 430 may be suitable to span opposite portions of transmitting region 218 shown in FIG. 2, for example, in order to more efficiently receive energy from power transmitter 108. Second end 438 of first elongated core member 402 and second end 442 of second elongated core member 422 may be fixedly connected together directly, connected together through an intermediate connecting member 446 of the same or different material, or first elongated core member 402 and second elongated core member 422 may be formed of a single piece core member 450 having two arms. Single piece core member 450 and each of the elongated core members (402, 422) may include a ferrous material for improved magnetic performance and transformer efficiency.

Power receiver 400 may include a first end member 454 connected to a first end 458 of first elongated core member 402. First end member 454 may be an elongated member 462 having a middle portion 466 that may be attached to first end 458 of first elongated core member 402. First end member may include a ferrous material and may be magnetically coupled to first elongated core member 402. Power receiver 400 may include a second end member 470 connected to a first end 474 of second elongated core member 422. Second end member 470 may be an elongated member 478 having a middle portion 482 that may be attached to first end 474 of second elongated core member 422. In this manner, power receiver 400 with first end member 454 and second end member 470 may resemble a dumbbell-shaped receiver coil. Second end member 470 may include a ferrous material and may be magnetically coupled to second elongated core member 422, and elongated core member 402 through intermediate connecting member 446 or direction connection between second end 438 of first elongated core member 402 with second end 442 of second elongated core member 422.

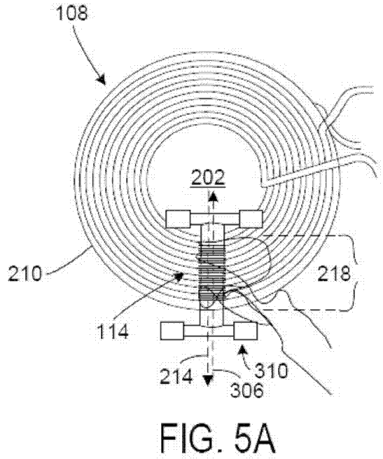

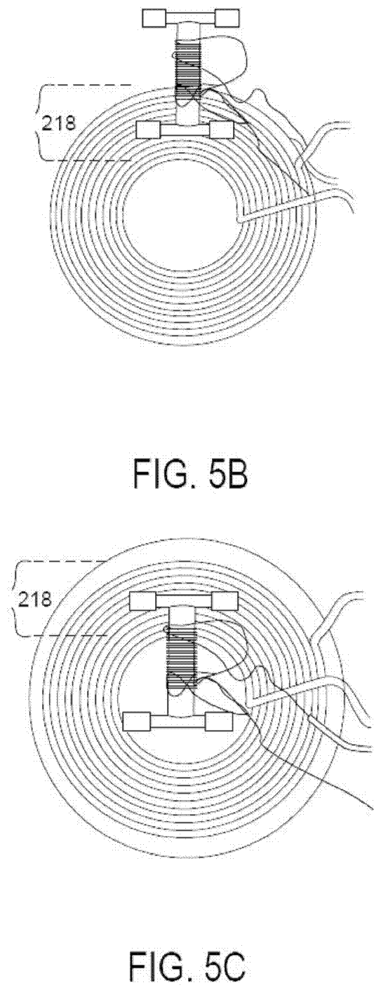

FIGS. 5A-5C illustrate exemplary placements of a receiver coil in proximity to a transmitter coil according to an embodiment. As illustrated, receiver conductor 114 may be positioned in proximity to transmitting region 218 in a fully or partially overlapping manner. FIG. 5A illustrates an exemplary placement of receiver coil 310 in proximity to transmitter coil 210 where receiver conductor 114 fully overlaps at portion transmitting region 218 and may rotationally aligned with transmitter coil radial axis 214. Stated differently, long axis 306 of elongated core member 302 of elongated receiver coil 310 may be substantially parallel with transmitter coil radial axis 214 and point toward center point 202 so that receiver conductor 114 may span and rest in proximity to transmitting region 218. As used herein, substantially parallel may include alignment within about +/−15 degrees. In this manner, elongated receiver coil 310 may receive maximum power from transmitter coil 210. FIG. 5B illustrates an exemplary placement of elongated receiver coil 310 in proximity to transmitter coil 210 where receiver conductor 114 partially overlaps at portion transmitting region 218. Similarly, FIG. 5C illustrates an exemplary placement of elongated receiver coil 310 in proximity to transmitter coil 210 where receiver conductor 114 partially overlaps at portion transmitting region 218.

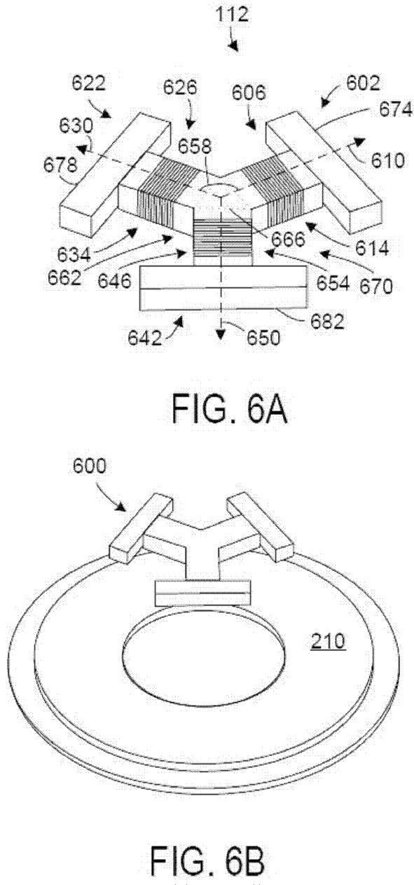

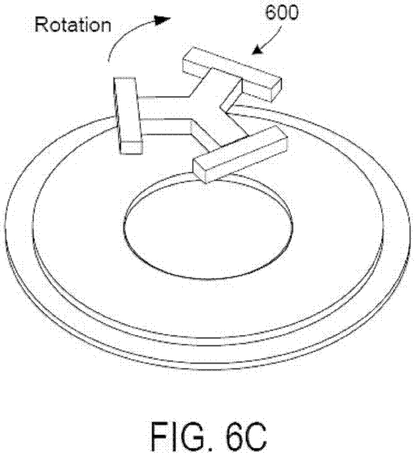

FIGS. 6A-6C are diagrams showing an example power receiver in a dumbbell configuration having three arms and placement of the power receiver adjacent to a power transmitter according to an embodiment. FIG. 6A illustrates an example power receiver 600. Power receiver 112, as a power receiver 600, may include a first elongated receiver coil 602 having a first elongated core member 606 with a first long axis 610 and a first receiver conductor 614 wound spirally around first elongated core member 606. Power receiver 600 further includes a second elongated core member 626 with a second long axis 630 and a second receiver conductor 634 wound spirally around second elongated core member 626 to form a second elongated receiver coil 622. Power receiver 600 further includes a third elongated core member 646 with a third long axis 650 and a third receiver conductor 654 wound spirally around third elongated core member 646 to form a third elongated receiver coil 642. First receiver conductor 614, second receiver conductor 634, and third receiver conductor 654 may be connected together serially. Second elongated core member 626 and third elongated core member 646 may be disposed at a 120-degree angle 658 from (e.g. on both sides of) first elongated core member 606, where second elongated core member 626 and third elongated core member 646 are disposed at 120-degrees on either side of first elongated core member 606.

Power receiver 600 may include a first end member 674 connected to a first end of first elongated core member 606; the first end member being an elongated member having a middle portion that may be attached to the first end of the first elongated core member. First end member 674 may include a ferrous material and may be magnetically coupled to first elongated core member 606. Power receiver 600 may include a second end member 678 connected to a first end of second elongated core member 626. Second end member 678 may be an elongated member having a middle portion that may be attached to the first end of the second elongated core member. Second end member 678 may include a ferrous material and may be magnetically coupled to second elongated core member 626. Power receiver 600 may include a third end member 682 connected to a first end of third elongated core member 646. Third end member 682 may be an elongated member having a middle portion that may be attached to a first end of third elongated core member 646. Third end member 682 may include a ferrous material and may be magnetically coupled to third elongated core member 646. A second end of first elongated core member 606, a second end of second elongated core member 626, and a second end of third elongated core member 646 may be one of connected together directly, connected together through an intermediate connecting member 662, connected together through a triangular connecting member 666, or formed of a single piece core member 670 having three arms. During mass production, first elongated core member 606, first end member 674, second elongated core member 626, second end member 678, third elongated core member 646, and third end member 682 may be formed as a whole, contiguous piece of ferrite in a molding process. FIG. 6B illustrates an exemplary placement of power receiver 600 relative to planar transmitter coil 210. FIG. 6C illustrates another exemplary placement of power receiver 600 relative to planar transmitter coil 210 where power receiver 600 may be rotated to a different orientation from what is shown in FIG. 6B. In this manner, by having multiple arms at different angles, power receiver 600 may be more robust against self-rotation, which enables wireless charging with more freedom.

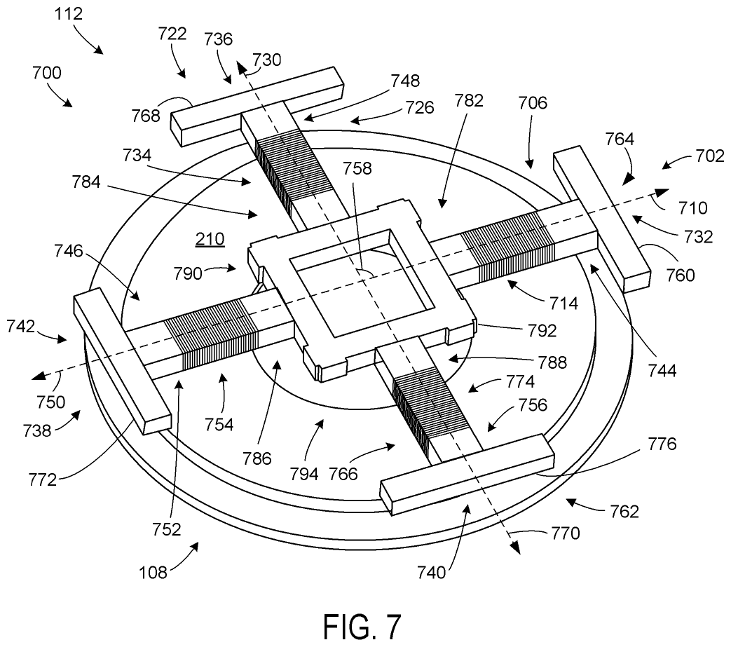

FIG. 7 is a diagram showing an example power receiver in a dumbbell configuration having four arms according to an embodiment. Power receiver 112, as an example power receiver 700, may include a first elongated receiver coil 702 having a first elongated core member 706 with a first long axis 710 and a first receiver conductor 714 wound spirally around first elongated core member 706. Power receiver 700 may also include a second elongated core member 726 with a second long axis 730 and a second receiver conductor 734 wound spirally around second elongated core member 726 to form a second elongated receiver coil 722. Power receiver 700 may further include a third elongated core member 746 with a third long axis 750 and a third receiver conductor 754 wound spirally around third elongated core member 746 to form a third elongated receiver coil 742. Finally, power receiver 700 may include a fourth elongated core member 766 with a fourth long axis 770 and a fourth receiver conductor 774 wound spirally around fourth elongated core member 766 to form a fourth elongated receiver coil 762. First receiver conductor 714, second receiver conductor 734, third receiver conductor 754, and fourth receiver conductor 774 may be connected together serially. Each of first elongated core member 706, second elongated core member 726, third elongated core member 746, and fourth elongated core member 766 may be disposed at a 90-degree angle 758 from each adjacent (e.g. neighboring) elongated core member. A second end 782 of first elongated core member 706 may be connected together with a second end 784 of second elongated core member 726, a second end 786 of third elongated core member 746, and a second end 788 of the fourth elongated core member. In this manner, second end 782 of first elongated core member 706, second end 784 of second elongated core member 726, second end 786 of third elongated core member 746, and second end 788 of fourth elongated core member 766 may be one of connected together directly, connected together through an intermediate connecting member 790, connected together through a square connecting member 792, and formed of a single piece core member 794 having four arms. Each of the elongated core members, intermediate connecting member 790, and single piece core member 794 may include ferrous material.

Power receiver 700 may further include a first end member 760 connected to a first end 744 first elongated core member 706. First end member 760 may be an elongated member 764 having a middle portion 732 that may be attached to first end 744 of first elongated core member 706. First end member 760 may include a ferrous material and may be magnetically coupled to first elongated core member 706. Power receiver 700 may also include a second end member 768 connected to a first end 748 of second elongated core member 726. Second end member 768 may be an elongated member having a middle portion 736 that may be attached to first end 748 of second elongated core member 726. Second end member 768 may include a ferrous material and may be magnetically coupled to second elongated core member 726. Power receiver 700 may further include a third end member 772 connected to a first end 752 of third elongated core member 746. Third end member 772 may be an elongated member having a middle portion 738 that may be attached to first end 752 of third elongated core member 746. Third end member 772 may include a ferrous material and may be magnetically coupled to third elongated core member 746. Finally, power receiver 700 may include a fourth end member 776 connected to a first end 756 of fourth elongated core member766. Fourth end member 776 may be an elongated member having a middle portion 740 that may be attached to first end 756 of fourth elongated core member 766. Fourth end member 776 may include a ferrous material and may be magnetically coupled to fourth elongated core member 766. The distance between first receiver conductor 714 and third receiver conductor 754 may be suitable to span opposite portions of a transmitting region shown of planar transmitting coil 210. Similarly, the distance between second receiver conductor 734 and fourth receiver conductor 774 may be suitable to span opposite portions planar transmitting coil 210. In this manner, the cross-shaped structure of power receiver 700 may more efficiently receive energy from power transmitter 108 through planar transmitting coil 210. During mass production, first elongated core member 706, first end member 760, second elongated core member 726, second end member 768, third elongated core member 746, third end member 772, fourth elongated core member 766, fourth end member 776 may be formed as a whole, contiguous piece of ferrite in a molding process.

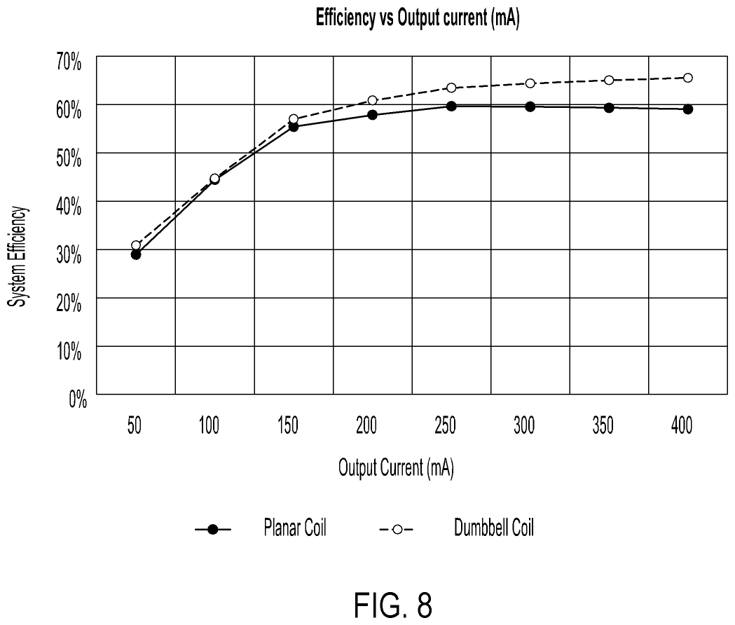

FIG. 8 is a chart showing a comparison based on system efficiency and output current for a planar coil and a dumbbell coil according to an embodiment. As shown in various embodiments, the disclosed elongated receiver coils may collect energy from planar transmitter coils in a horizontal direction (e.g. lateral direction) as well as a vertical direction (e.g. normal from the plane 206 of the planar transmitter coils) which may effectively enlarge the charging area as well as improve the charging efficiency. Further, due to the geometry of the disclosed receiver coils, the system efficiency (e.g. quality or Q-factor) may be much higher than a planar receiver coil having the same size or footprint.

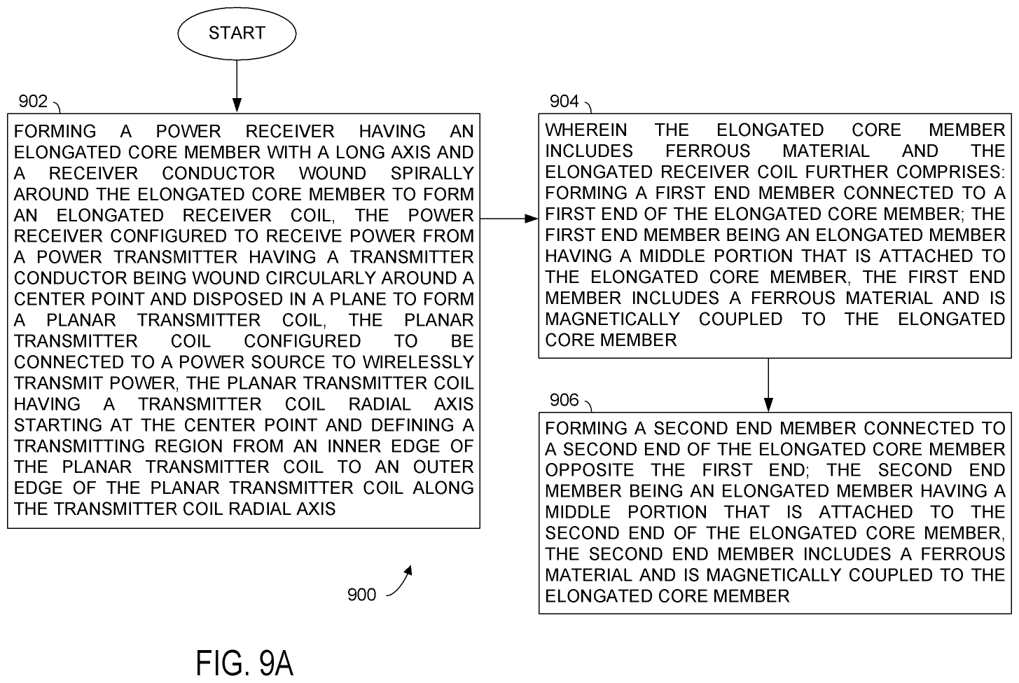

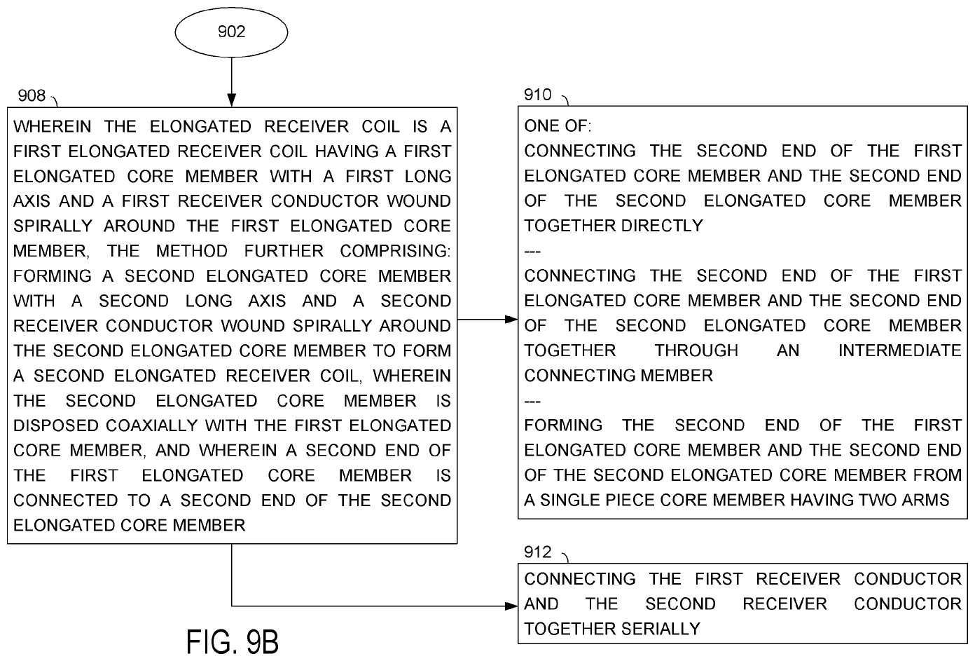

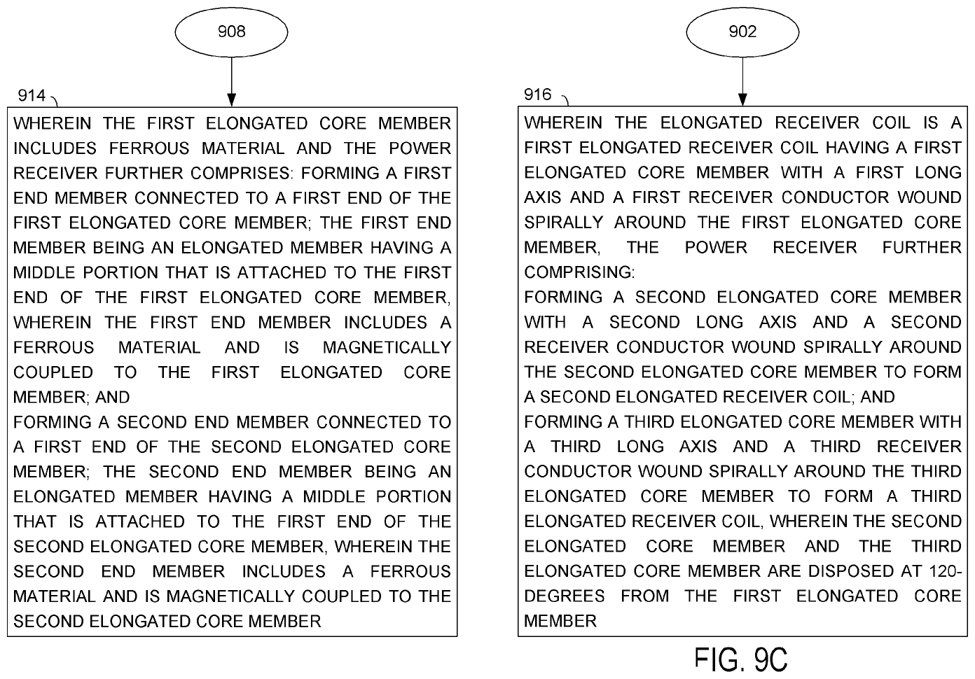

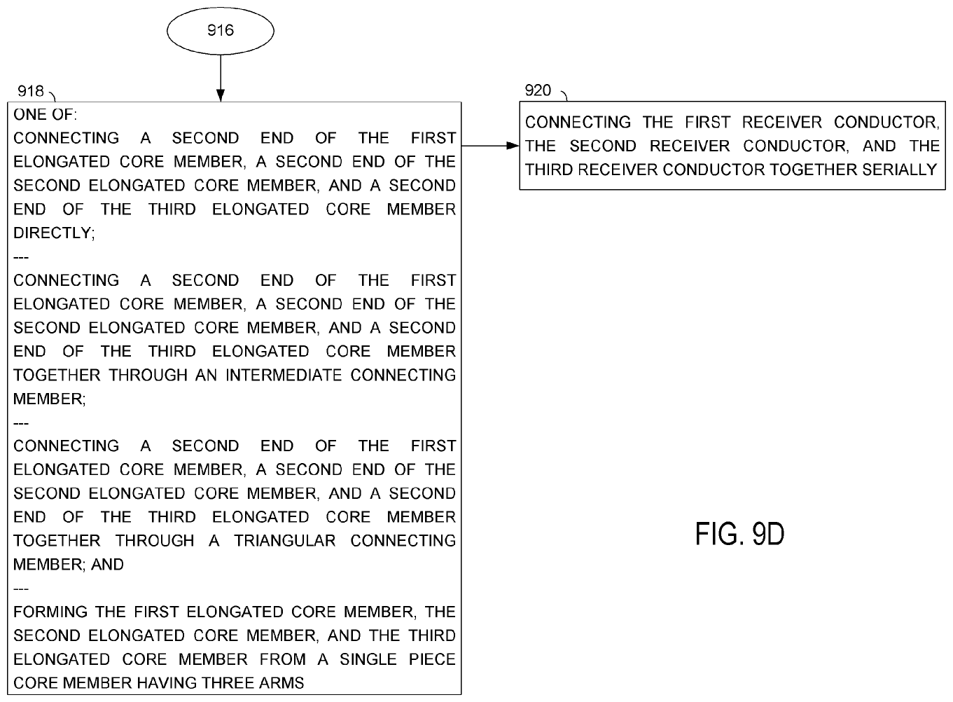

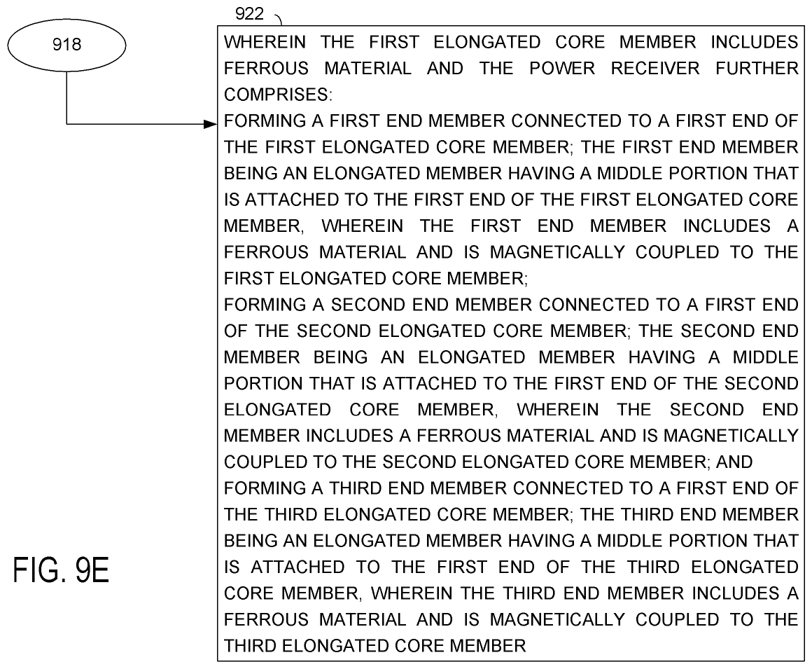

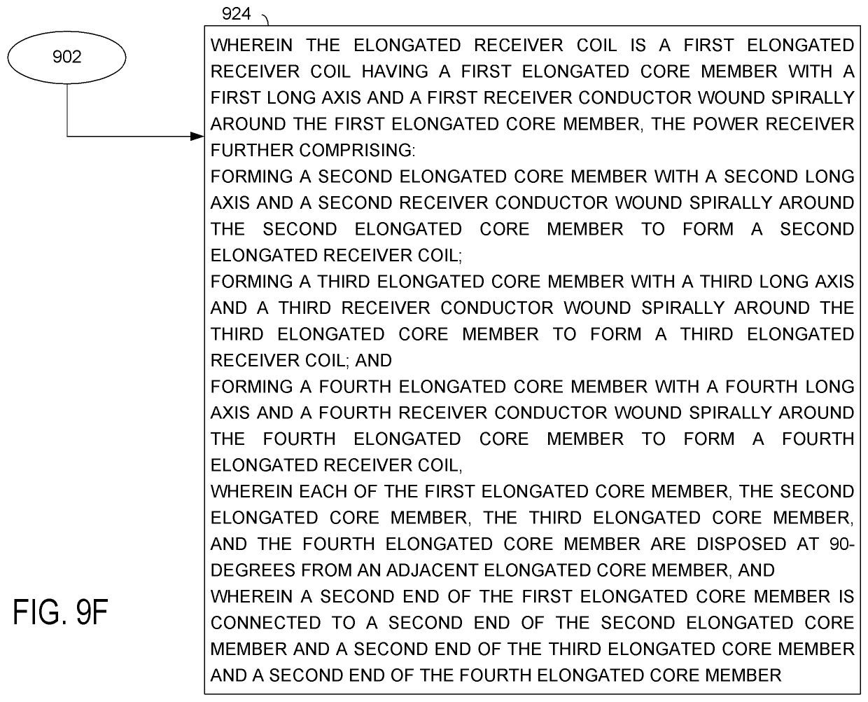

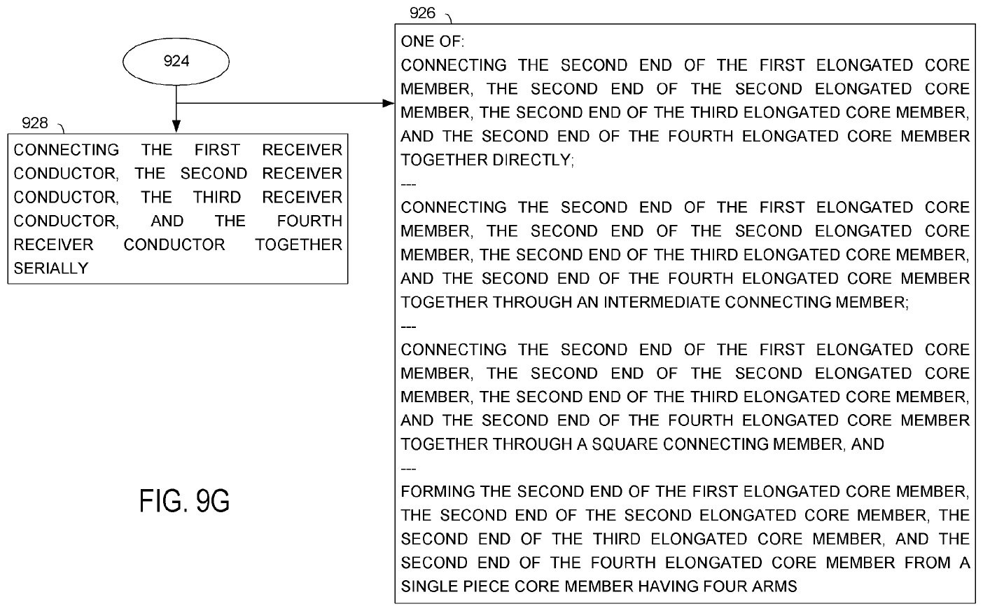

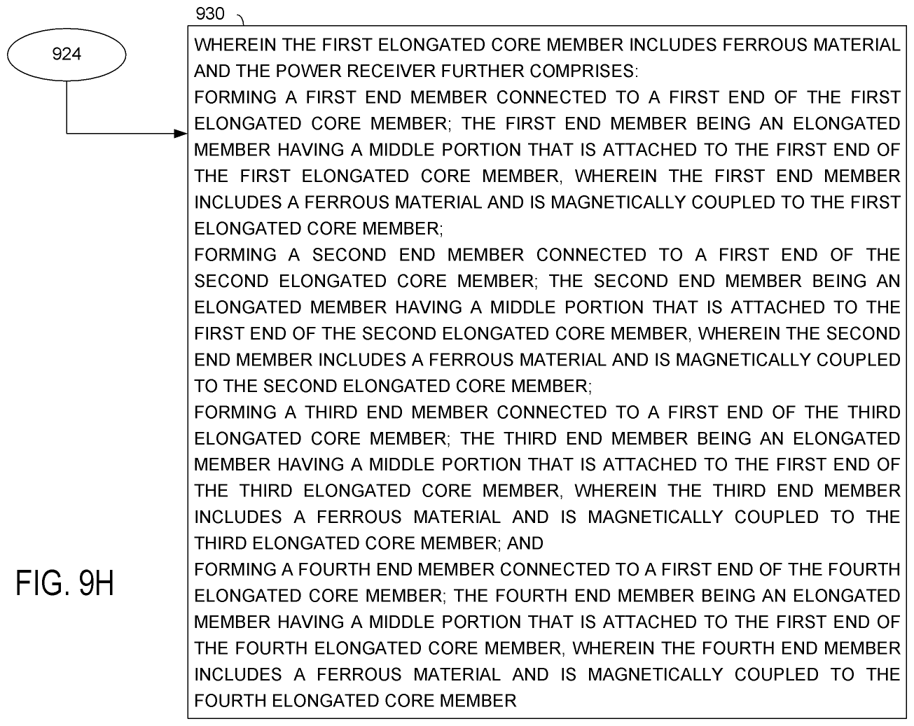

FIGS. 9A-9H are a flow diagram of methods according to various embodiments. In reference FIG. 1 to FIG. 7, FIG. 9A illustrates a method 900 of constructing a wireless power apparatus that may begin in step 902 including forming a power receiver 300 (also including forming power receivers 400, 600, 700) having an elongated core member 302 with a long axis 306 and a receiver conductor 114 wound spirally around the elongated core member to form an elongated receiver coil 310. Power receiver 300 may be configured to receive power from a power transmitter 108 having a transmitter conductor 110 being wound circularly around a center point 202 and disposed in a plane 206 to form a planar transmitter coil 210 to be connected to an alternating current power source 104 to wirelessly transmit power. Planar transmitter coil 210 may have a transmitter coil radial axis 214 starting at center point 202 and defining a transmitting region 218 from an inner edge 222 of planar transmitter coil 210 to an outer edge 226 of planar transmitter coil 210 along transmitter coil radial axis 214.

Method 900 may continue with step 904, wherein elongated core member 302 may include ferrous material and elongated receiver coil 310, and method 900 may further comprise forming 904 a first end member 314 connected to a first end 318 of the core member. First end member 314 may be an elongated member 322 having a middle portion 326 that may be attached to elongated core member 302. First end member 314 may include a ferrous material and may be magnetically coupled to elongated core member 302.

Method 900 may continue with step 906, wherein elongated receiver coil 310 may further comprise forming 906 a second end member 330 connected to a second end 334 of the elongated core member opposite first end 318. Second end member 330 may be an elongated member 338 having a middle portion 342 that may be attached to second end 334 of elongated core member 302. Second end member 330 may include a ferrous material and may be magnetically coupled to elongated core member 302.

In reference FIG. 1 to FIG. 7, FIG. 9B illustrates method 900 may continue with step 908, wherein the elongated receiver coil may be a first elongated receiver coil 410 having a first elongated core member 402 with a first long axis 406 and a first receiver conductor 414 wound spirally around the first elongated core member, method 900 may continue with forming 908 a second elongated core member 422 with a second long axis 426 and a second receiver conductor 430 wound spirally around second elongated core member 422 to form a second elongated receiver coil 434. Second elongated core member 422 may be disposed coaxially with first elongated core member 402. A second end 438 of first elongated core member 402 may be connected to a second end 442 of second elongated core member 422.

Method 900 may continue with step 910, including one of connecting 910 second end 438 of first elongated core member 402 and second end 442 of second elongated core member 422 together directly, connecting 910 second end 438 of first elongated core member 402 and second end 442 of second elongated core member 422 together through an intermediate connecting member 446, and forming 910 second end 438 of first elongated core member 402 and second end 442 of second elongated core member 422 from a single piece core member 450 having two arms.

Method 900 may continue with step 912, including connecting 912 first receiver conductor 414 and second receiver conductor 430 together serially.

In reference FIG. 1 to FIG. 7, FIG. 9C illustrates method 900 may continue with step 914, wherein the first elongated core member includes ferrous material, method 900 may further comprise forming 914 a first end member 454 connected to a first end 458 of first elongated core member 402. First end member 454 may be an elongated member 462 having a middle portion 466 that may be attached to first end 458 of first elongated core member 402. First end member 454 may include a ferrous material and may be magnetically coupled to first elongated core member 402. Method 900 may continue with forming 914 a second end member 470 connected to a first end 474 of second elongated core member 422. Second end member 470 may be an elongated member 478 having a middle portion 482 that may be attached to first end 474 of second elongated core member 422. Second end member 470 may include a ferrous material and may be magnetically coupled to second elongated core member 422.

Method 900 may continue with step 916, wherein the elongated receiver coil may be a first elongated receiver coil 602 having a first elongated core member 606 with a first long axis 610 and a first receiver conductor 614 wound spirally around first elongated core member 606, the method may further comprise forming 916 a second elongated core member 626 with a second long axis 630 and a second receiver conductor 634 wound spirally around second elongated core member 626 to form a second elongated receiver coil 622. Method 900 may continue with forming 916 a third elongated core member 646 with a third long axis 650 and a third receiver conductor 654 wound spirally around the third elongated core member to form a third elongated receiver coil 642. Second elongated core member 626 and third elongated core member 646 may be disposed at a 120-degree angle 658 from first elongated core member 606.

In reference FIG. 1 to FIG. 7, FIG. 9D illustrates method 900 may continue with step 918, including one connecting 918 a second end of first elongated core member 606, a second end of second elongated core member 626, and a second end of third elongated core member 646 directly, connecting 918 a second end of first elongated core member 606, a second end of second elongated core member 626, and a second end of third elongated core member 646 together through an intermediate connecting member 662, connecting 918 a second end of first elongated core member 606, a second end of second elongated core member 626, and a second end of third elongated core member 646 together through a triangular connecting member 666, and forming 918 first elongated core member 606, second elongated core member 626, and third elongated core member 646 from a single piece core member 670 having three arms.

Method 900 may continue with step 920, and may further include connecting 920 first receiver conductor 614, second receiver conductor 634, and third receiver conductor 654 together serially.

In reference FIG. 1 to FIG. 7, FIG. 9E illustrates method 900 may continue with step 922, wherein the first elongated core member includes ferrous material, the method 900 may further comprise forming 922 a first end member 674 connected to a first end of first elongated core member 606. First end member 674 may be an elongated member having a middle portion that may be attached to the first end of first elongated core member 606. First end member 674 may include a ferrous material and may be magnetically coupled to first elongated core member 606. Method 900 may further include forming 922 a second end member 678 connected to a first end of second elongated core member 626. Second end member 678 may be an elongated member having a middle portion that may be attached to the first end of second elongated core member 626. Second end member may include a ferrous material and may be magnetically coupled to second elongated core member 626. Method 900 may further include forming 922 a third end member 682 connected to a first end of third elongated core member 646. Third end member may be an elongated member having a middle portion that may be attached to the first end of third elongated core member 646. Third end member may include a ferrous material and may be magnetically coupled to third elongated core member 646.

In reference FIG. 1 to FIG. 7, FIG. 9F illustrates method 900 may continue with step 924, wherein the elongated receiver coil may be a first elongated receiver coil 702 having a first elongated core member 706 with a first long axis 710 and a first receiver conductor 714 wound spirally around first elongated core member 706. The method 900 may further comprise forming 924 a second elongated core member 726 with a second long axis 730 and a second receiver conductor 734 wound spirally around the second elongated core member to form a second elongated receiver coil 722. Method 900 may continue with forming 924 a third elongated core member 746 with a third long axis 750 and a third receiver conductor 754 wound spirally around third elongated core member 746 to form a third elongated receiver coil 742. Method 900 may continue with forming 924 a fourth elongated core member 766 with a fourth long axis 770 and a fourth receiver conductor 774 wound spirally around the fourth elongated core member to form a fourth elongated receiver coil 762. First elongated core member 706, second elongated core member 726, third elongated core member 746, and fourth elongated core member 766 may be disposed at a 90-degree angle from an adjacent elongated core member. A second end 782 of first elongated core member 706 may be connected to a second end 784 of second elongated core member 726 and a second end 786 of third elongated core member 746 and a second end 788 of fourth elongated core member 766.

In reference FIG. 1 to FIG. 7, FIG. 9G illustrates method 900 may continue with step 926, including one of connecting 926 second end 782 of first elongated core member 706, second end 784 of second elongated core member 726, second end 786 of third elongated core member 746, and second end 788 of fourth elongated core member 766 together directly, connecting second end 784 of first elongated core member 706, second end 784 of second elongated core member 726, second end 786 of third elongated core member 746, and second end 788 of fourth elongated core member 766 together through an intermediate connecting member 790, connecting 926 second end 782 of first elongated core member 706, second end 784 of second elongated core member 726, second end 786 of third elongated core member 746, and second end 788 of fourth elongated core member 766 together through a square connecting member 792, and forming 926 second end of first elongated core member 706, second end 784 of second elongated core member 726, second end 786 of third elongated core member 746, and second end 788 of fourth elongated core member 766 from a single piece core member 794 having four arms.

Method 900 may continue with step 928, including connecting 928 first receiver conductor 714, second receiver conductor 734, third receiver conductor 754, and fourth receiver conductor 774 together serially.

In reference FIG. 1 to FIG. 7, FIG. 9H illustrates method 900 may continue with step 930, wherein the first elongated core member 706 may include ferrous material and the method 900 may further comprise forming 930 a first end member 760 connected to a first end 744 of first elongated core member 706. First end member 760 may be an elongated member 764 having a middle portion 732 that may be attached to first end 744 of first elongated core member 706. First end member 760 may include a ferrous material and may be magnetically coupled to first elongated core member 706. Method 900 may further comprise forming 930 a second end member 768 connected to a first end 748 of second elongated core member 726. Second end member 768 may be an elongated member having a middle portion that may be attached to first end 748 of the second elongated core member. Second end member 768 may include a ferrous material and may be magnetically coupled to second elongated core member 726. Method 900 may further comprise forming 930 a third end member 772 connected to a first end of third elongated core member 746. Third end member 772 may be an elongated member having a middle portion 738 that may be attached to first end 786 of third elongated core member 746. Third end member 772 may include a ferrous material and may be magnetically coupled to third elongated core member 746. Method 900 may continue with forming 930 a fourth end member 776 connected to a first end 788 of fourth elongated core member 766. Fourth end member 776 may be an elongated member having a middle portion 740 that may be attached to the first end of the fourth elongated core member, wherein the fourth end member includes a ferrous material and is magnetically coupled to the fourth elongated core member.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A wireless power apparatus, comprising:
a power receiver having an elongated core member with a long axis and a receiver conductor wound spirally around the elongated core member to form an elongated receiver coil, the power receiver configured to receive power from a power transmitter having a transmitter conductor being wound circularly around a center point and disposed in a plane to form a planar transmitter coil, the planar transmitter coil configured to be connected to an alternating current power source to wirelessly transmit power, the planar transmitter coil having a transmitter coil radial axis starting at the center point and defining a transmitting region from an inner edge of the planar transmitter coil to an outer edge of the planar transmitter coil along the transmitter coil radial axis.

2. The wireless power apparatus of claim 1, further comprising:
a load connected to the elongated receiver coil and configured to receive power from the planar transmitter coil when the elongated receiver coil is in proximity to the transmitting region.

3. The wireless power apparatus of claim 1, wherein the elongated receiver coil is positioned to at least partially overlap the transmitting region.

4. The wireless power apparatus of claim 1, wherein the elongated core member long axis is aligned with the transmitter coil radial axis.

5. The wireless power apparatus of claim 4, wherein the elongated core member includes one of a ferrous material and a non-ferrous material.

6. The wireless power apparatus of claim 5, wherein the elongated core member includes ferrous material and the elongated receiver coil further comprises:
a first end member connected to a first end of the elongated core member; the first end member being an elongated member having a middle portion that is attached to the first end of the elongated core member, the first end member includes a ferrous material and is magnetically coupled to the elongated core member.

7. The wireless power apparatus of claim 6, wherein the elongated receiver coil further comprises:
a second end member connected to a second end of the elongated core member opposite the first end; the second end member being an elongated member having a middle portion that is attached to the second end of the elongated core member, the second end member includes a ferrous material and is magnetically coupled to the elongated core member.

8. The wireless power apparatus of claim 1, wherein the elongated receiver coil is a first elongated receiver coil having a first elongated core member with a first long axis and a first receiver conductor wound spirally around the first elongated core member, the power receiver further comprising:
a second elongated core member with a second long axis and a second receiver conductor wound spirally around the second elongated core member to form a second elongated receiver coil,
wherein the second elongated core member is disposed coaxially with the first elongated core member, and
wherein a second end of the first elongated core member is connected to a second end of the second elongated core member.

9. The wireless power apparatus of claim 8, wherein at least one of:
the second end of the first elongated core member and the second end of the second elongated core member are one of connected together directly, the second end of the first elongated core member and the second end of the second elongated core member are one of connected together connected together through an intermediate connecting member, and the second end of the first elongated core member and the second end of the second elongated core member are formed of a single piece core member having two arms,
the first receiver conductor and the second receiver conductor are connected together serially, and
the first elongated core member includes ferrous material and the power receiver further comprises:
a first end member connected to a first end of the first elongated core member; the first end member being an elongated member having a middle portion that is attached to the first end of the first elongated core member, wherein the first end member includes a ferrous material and is magnetically coupled to the first elongated core member; and
a second end member connected to a first end of the second elongated core member; the second end member being an elongated member having a middle portion that is attached to the first end of the second elongated core member, wherein the second end member includes a ferrous material and is magnetically coupled to the second elongated core member.

10. The wireless power apparatus of claim 1,
wherein the elongated receiver coil is a first elongated receiver coil having a first elongated core member with a first long axis and a first receiver conductor wound spirally around the first elongated core member, the power receiver further comprising:
a second elongated core member with a second long axis and a second receiver conductor wound spirally around the second elongated core member to form a second elongated receiver coil; and
a third elongated core member with a third long axis and a third receiver conductor wound spirally around the third elongated core member to form a third elongated receiver coil,
wherein the second elongated core member and the third elongated core member are disposed at 120-degrees from the first elongated core member.

11. The wireless power apparatus of claim 10, wherein at least one of:
a second end of the first elongated core member, a second end of the second elongated core member, and a second end of the third elongated core member are one of connected together directly, connected together through an intermediate connecting member, connected together through a triangular connecting member, and formed of a single piece core member having three arms,
the first receiver conductor, the second receiver conductor, and the third receiver conductor are connected together serially, and
the first elongated core member includes ferrous material and the power receiver further comprises:
a first end member connected to a first end of the first elongated core member; the first end member being an elongated member having a middle portion that is attached to the first end of the first elongated core member, wherein the first end member includes a ferrous material and is magnetically coupled to the first elongated core member;
a second end member connected to a first end of the second elongated core member; the second end member being an elongated member having a middle portion that is attached to the first end of the second elongated core member, wherein the second end member includes a ferrous material and is magnetically coupled to the second elongated core member; and
a third end member connected to a first end of the third elongated core member; the third end member being an elongated member having a middle portion that is attached to the first end of the third elongated core member, wherein the third end member includes a ferrous material and is magnetically coupled to the third elongated core member.

12. The wireless power apparatus of claim 1, wherein the elongated receiver coil is a first elongated receiver coil having a first elongated core member with a first long axis and a first receiver conductor wound spirally around the first elongated core member, the power receiver further comprising:
a second elongated core member with a second long axis and a second receiver conductor wound spirally around the second elongated core member to form a second elongated receiver coil;
a third elongated core member with a third long axis and a third receiver conductor wound spirally around the third elongated core member to form a third elongated receiver coil; and
a fourth elongated core member with a fourth long axis and a fourth receiver conductor wound spirally around the fourth elongated core member to form a fourth elongated receiver coil,
wherein each of the first elongated core member, the second elongated core member, the third elongated core member, and the fourth elongated core member are disposed at 90-degrees from an adjacent elongated core member, and
wherein a second end of the first elongated core member is connected to a second end of the second elongated core member and a second end of the third elongated core member and a second end of the fourth elongated core member.

13. The wireless power apparatus of claim 12, wherein at least one of:
the second end of the first elongated core member, the second end of the second elongated core member, the second end of the third elongated core member, and the second end of the fourth elongated core member are one of connected together directly, connected together through an intermediate connecting member, connected together through a square connecting member, and formed of a single piece core member having four arms,
wherein the first receiver conductor, the second receiver conductor, the third receiver conductor, and the fourth receiver conductor are connected together serially, and
wherein the first elongated core member includes ferrous material and the power receiver further comprises:
a first end member connected to a first end of the first elongated core member; the first end member being an elongated member having a middle portion that is attached to the first end of the first elongated core member, wherein the first end member includes a ferrous material and is magnetically coupled to the first elongated core member;
a second end member connected to a first end of the second elongated core member; the second end member being an elongated member having a middle portion that is attached to the first end of the second elongated core member, wherein the second end member includes a ferrous material and is magnetically coupled to the second elongated core member;
a third end member connected to a first end of the third elongated core member; the third end member being an elongated member having a middle portion that is attached to the first end of the third elongated core member, wherein the third end member includes a ferrous material and is magnetically coupled to the third elongated core member; and
a fourth end member connected to a first end of the fourth elongated core member; the fourth end member being an elongated member having a middle portion that is attached to the first end of the fourth elongated core member, wherein the fourth end member includes a ferrous material and is magnetically coupled to the fourth elongated core member.

14. A method for constructing a wireless power apparatus, the method comprising:
forming a power receiver having an elongated core member with a long axis and a receiver conductor wound spirally around the elongated core member to form an elongated receiver coil, the power receiver configured to receive power from a power transmitter having a transmitter conductor being wound circularly around a center point and disposed in a plane to form a planar transmitter coil, the planar transmitter coil configured to be connected to an alternating current power source to wirelessly transmit power, the planar transmitter coil having a transmitter coil radial axis starting at the center point and defining a transmitting region from an inner edge of the planar transmitter coil to an outer edge of the planar transmitter coil along the transmitter coil radial axis.

15. The method for constructing a wireless power apparatus of claim 14, wherein the elongated core member includes ferrous material and the elongated receiver coil further comprises:
forming a first end member connected to a first end of the elongated core member; the first end member being an elongated member having a middle portion that is attached to the elongated core member, the first end member including a ferrous material being magnetically coupled to the elongated core member.

16. The method for constructing a wireless power apparatus of claim 15, wherein the elongated receiver coil further comprises:
forming a second end member connected to a second end of the elongated core member opposite the first end; the second end member being an elongated member having a middle portion that is attached to the second end of the elongated core member, the second end member includes a ferrous material and is magnetically coupled to the elongated core member.

17. The method for constructing a wireless power apparatus of claim 14, wherein the elongated receiver coil is a first elongated receiver coil having a first elongated core member with a first long axis and a first receiver conductor wound spirally around the first elongated core member, the method further comprising:
forming a second elongated core member with a second long axis and a second receiver conductor wound spirally around the second elongated core member to form a second elongated receiver coil,
wherein the second elongated core member is disposed coaxially with the first elongated core member, and
wherein a second end of the first elongated core member is connected to a second end of the second elongated core member.

18. The method for constructing a wireless power apparatus of claim 17, the method further comprising at least one of:
connecting the second end of the first elongated core member and the second end of the second elongated core member together directly;
connecting the second end of the first elongated core member and the second end of the second elongated core member together through an intermediate connecting member; and
forming the second end of the first elongated core member and the second end of the second elongated core member from a single piece core member having two arms,
connecting the first receiver conductor and the second receiver conductor together serially, and
wherein the first elongated core member includes ferrous material, the method further comprising:
forming a first end member connected to a first end of the first elongated core member; the first end member being an elongated member having a middle portion that is attached to the first end of the first elongated core member, wherein the first end member includes a ferrous material and is magnetically coupled to the first elongated core member; and
forming a second end member connected to a first end of the second elongated core member; the second end member being an elongated member having a middle portion that is attached to the first end of the second elongated core member, wherein the second end member includes a ferrous material and is magnetically coupled to the second elongated core member.

19. The method for constructing a wireless power apparatus of claim 14, wherein the elongated receiver coil is a first elongated receiver coil having a first elongated core member with a first long axis and a first receiver conductor wound spirally around the first elongated core member, the method further comprising:
forming a second elongated core member with a second long axis and a second receiver conductor wound spirally around the second elongated core member to form a second elongated receiver coil; and
forming a third elongated core member with a third long axis and a third receiver conductor wound spirally around the third elongated core member to form a third elongated receiver coil,
wherein the second elongated core member and the third elongated core member are disposed at 120-degrees from the first elongated core member.

20. The method for constructing a wireless power apparatus of claim 19, the method further comprising at least one of:
connecting a second end of the first elongated core member, a second end of the second elongated core member, and a second end of the third elongated core member directly;
connecting a second end of the first elongated core member, a second end of the second elongated core member, and a second end of the third elongated core member together through an intermediate connecting member;
connecting a second end of the first elongated core member, a second end of the second elongated core member, and a second end of the third elongated core member together through a triangular connecting member; and
forming the first elongated core member, the second elongated core member, and the third elongated core member from a single piece core member having three arms,
connecting the first receiver conductor, the second receiver conductor, and the third receiver conductor together serially, and
wherein the first elongated core member includes ferrous material, the method further comprising:
forming a first end member connected to a first end of the first elongated core member; the first end member being an elongated member having a middle portion that is attached to the first end of the first elongated core member, wherein the first end member includes a ferrous material and is magnetically coupled to the first elongated core member;
forming a second end member connected to a first end of the second elongated core member; the second end member being an elongated member having a middle portion that is attached to the first end of the second elongated core member, wherein the second end member includes a ferrous material and is magnetically coupled to the second elongated core member; and
forming a third end member connected to a first end of the third elongated core member; the third end member being an elongated member having a middle portion that is attached to the first end of the third elongated core member, wherein the third end member includes a ferrous material and is magnetically coupled to the third elongated core member.

21. The method for constructing a wireless power apparatus of claim 14, wherein the elongated receiver coil is a first elongated receiver coil having a first elongated core member with a first long axis and a first receiver conductor wound spirally around the first elongated core member, the method further comprising:
forming a second elongated core member with a second long axis and a second receiver conductor wound spirally around the second elongated core member to form a second elongated receiver coil;
forming a third elongated core member with a third long axis and a third receiver conductor wound spirally around the third elongated core member to form a third elongated receiver coil; and
forming a fourth elongated core member with a fourth long axis and a fourth receiver conductor wound spirally around the fourth elongated core member to form a fourth elongated receiver coil,
wherein each of the first elongated core member, the second elongated core member, the third elongated core member, and the fourth elongated core member are disposed at 90-degrees from an adjacent elongated core member, and
wherein a second end of the first elongated core member is connected to a second end of the second elongated core member and a second end of the third elongated core member and a second end of the fourth elongated core member.

22. The method for constructing a wireless power apparatus of claim 21, the method further comprising at least one of:
connecting the second end of the first elongated core member, the second end of the second elongated core member, the second end of the third elongated core member, and the second end of the fourth elongated core member together directly;
connecting the second end of the first elongated core member, the second end of the second elongated core member, the second end of the third elongated core member, and the second end of the fourth elongated core member together through an intermediate connecting member;
connecting the second end of the first elongated core member, the second end of the second elongated core member, the second end of the third elongated core member, and the second end of the fourth elongated core member together through a square connecting member, and
forming the second end of the first elongated core member, the second end of the second elongated core member, the second end of the third elongated core member, and the second end of the fourth elongated core member from a single piece core member having four arms,
connecting the first receiver conductor, the second receiver conductor, the third receiver conductor, and the fourth receiver conductor together serially, and
wherein the first elongated core member includes ferrous material and the method further comprising:
forming a first end member connected to a first end of the first elongated core member; the first end member being an elongated member having a middle portion that is attached to the first end of the first elongated core member, wherein the first end member includes a ferrous material and is magnetically coupled to the first elongated core member;
forming a second end member connected to a first end of the second elongated core member; the second end member being an elongated member having a middle portion that is attached to the first end of the second elongated core member, wherein the second end member includes a ferrous material and is magnetically coupled to the second elongated core member;
forming a third end member connected to a first end of the third elongated core member; the third end member being an elongated member having a middle portion that is attached to the first end of the third elongated core member, wherein the third end member includes a ferrous material and is magnetically coupled to the third elongated core member; and
forming a fourth end member connected to a first end of the fourth elongated core member; the fourth end member being an elongated member having a middle portion that is attached to the first end of the fourth elongated core member, wherein the fourth end member includes a ferrous material and is magnetically coupled to the fourth elongated core member.

23. A wireless power system, comprising:
an alternating current power source configured to provide electrical power;
a power transmitter having a transmitter conductor being wound circularly around a center point and disposed in a plane to form a planar transmitter coil, the planar transmitter coil configured to be connected to the alternating current power source to wirelessly transmit power, the planar transmitter coil having a transmitter coil radial axis starting at the center point and defining a transmitting region from an inner edge of the planar transmitter coil to an outer edge of the planar transmitter coil along the transmitter coil radial axis;
a power receiver having an elongated core member with a long axis and a receiver conductor wound spirally around the elongated core member to form an elongated receiver coil; and
a load connected to the elongated receiver coil and configured to receive power from the planar transmitter coil when the elongated receiver coil is in proximity to the transmitting region.

24. The wireless power system of claim 23, wherein at least one of:
the elongated receiver coil is positioned to at least partially overlap the transmitting region,
the elongated core member long axis is aligned with the transmitter coil radial axis,
the elongated core member includes one of a ferrous material and a non-ferrous material,
the elongated core member includes ferrous material and the elongated receiver coil further comprises:
a first end member connected to a first end of the elongated core member; the first end member being an elongated member having a middle portion that is attached to the first end of the elongated core member,
wherein the first end member includes a ferrous material and is magnetically coupled to the elongated core member, and
the elongated receiver coil further comprises:
a second end member connected to a second end of the elongated core member opposite the elongated core member first end; the second end member being an elongated member having a middle portion that is attached to the second end of the elongated core member,
wherein the second end member includes a ferrous material and is magnetically coupled to the elongated core member.

25. The wireless power system of claim 23, wherein the elongated receiver coil is a first elongated receiver coil having a first elongated core member with a first long axis and a first receiver conductor wound spirally around the first elongated core member, the power receiver further comprising:
a second elongated core member with a second long axis and a second receiver conductor wound spirally around the second elongated core member to form a second elongated receiver coil,
wherein the second elongated core member is disposed coaxially with the first elongated core member, and
wherein a second end of the first elongated core member is connected to a second end of the second elongated core member, and
wherein at least one of:
the second end of the first elongated core member and the second end of the second elongated core member are one of connected together directly, connected together through an intermediate connecting member, and formed of a single piece core member having two arms,
the first elongated core member includes ferrous material and the power receiver further comprises:
a first end member connected to a first end of the first elongated core member; the first end member being an elongated member having a middle portion that is attached to the first end of the first elongated core member, wherein the first end member includes a ferrous material and is magnetically coupled to the first elongated core member; and
a second end member connected to a first end of the second elongated core member; the second end member being an elongated member having a middle portion that is attached to the first end of the second elongated core member, wherein the second end member includes a ferrous material and is magnetically coupled to the second elongated core member, and
the first receiver conductor and the second receiver conductor are connected together serially.
